(19) United States
(12) Patent Application Publication
(10) Pub. No.: US 2004/0124975 A1
(43) Pub. Date: Jul. 1, 2004

(54) Electronic apparatus and data processing method

(75) Inventors: Kenji Fujiwara, Ome-shi (JP); Yoshiki Yasui, Hamura-shi (JP)

Correspondence Address: Finnegan, Henderson, Farabow,, Garrett & Dunner, L.L.P., 1300 I Street, N.W., Washington, DC, 20005-0015, US

(73) Assignee: KABUSHIKI KAISHA TOSHIBA

(21) Appl. No.: 10/737,978

(22) Filed: Dec. 18, 2003

(30) Foreign Application Priority Data
Dec. 27, 2002 (JP) 2002-380273

(51) Int. Cl. G08B 29/00

(52) U.S. Cl. 340/506

(57) ABSTRACT

A security process setup module sets security processes of important data upon occurrence of emergency situations for respective data and respective types of emergency situations, and stores the setup contents in a security process setup table. An emergency situation detection module monitors signals from a LAN and the Internet. Upon detection of occurrence of any emergency situation based on any received signal, the module advises a security process execution module accordingly. Upon reception of this advice, the security process execution module executes the security processes of important data for respective data and the respective types of emergency situations on the basis of the security process setup table.

### CROSS-REFERENCE TO RELATED APPLICATIONS

This application is based upon and claims the benefit of priority from the prior Japanese Patent Application No. 2002-380273, filed Dec. 27, 2002, the entire contents of which are incorporated herein by reference.

### BACKGROUND OF THE INVENTION

1. Field of the Invention

The present invention relates to a data security technique that prevents data losses due to disasters, data theft by malicious individuals, and the like.

2. Description of the Related Art

In recent years, electronic commerce that exploits the Internet is beginning to prevail. In this electronic commerce, since a transaction between a vendor and customer, i.e., exchange of data associated with placement and receipt of an order and the like is made via a public network, various authentication and encryption technologies are adopted to assure security.

Upon using such authentication and encryption technologies, each customer normally possesses an ID number, password, public key, and the like. Therefore, it is important to assure not only the security of data transmitted on the Internet but also that of data that each customer stores on, e.g., a magnetic disk (HDD).

For example, Jpn. Pat. Appln. KOKAI Publication No. 8-314805 describes a wireless portable terminal illicit use prevention system, which saves internal data in an information center if a wrong password is repetitively input beyond a prescribed number of times, and erases the internal data after saving. According to this wireless portable terminal illicit use prevention system, data stored in a wireless portable terminal can be prevented from being illicitly used by a third party and a loss of data can also be prevented when that terminal has been lost or stolen.

Security of data stored in an electronic apparatus called, e.g., a home server, which is set up in a room, will be examined below. Such a stationary electronic apparatus has a large-capacity storage medium, which stores various data in large quantities. If various measures can be taken for these data in large quantities in accordance with emergency situations, more flexible management can be made. However, the aforementioned system described in Jpn. Pat. Appln. KOKAI Publication No. 8-314805 cannot make such setups.

### BRIEF SUMMARY OF THE INVENTION

According to an embodiment of the present invention, an electronic apparatus comprises a storage unit which stores data, a setting unit configured to set a predetermined process to be taken for data stored in the storage unit upon occurrence of an event, a detection unit configured to detect if the event has occurred, and a data processing unit configured to take the predetermined process set by the setting unit, when the detection unit detects that the event has occurred.

### BRIEF DESCRIPTION OF THE SEVERAL VIEWS OF THE DRAWING

The accompanying drawings, which are incorporated in and constitute a part of the specification, illustrate presently embodiments of the invention, and together with the general description given above and the detailed description of the embodiments given below, serve to explain the principles of the invention.

FIG. 1 is a diagram showing the use pattern of an electronic apparatus (home server) according to an embodiment of the present invention;

FIG. 2 is a block diagram showing the device arrangement of the electronic apparatus (home server) according to the embodiment of the present invention;

FIG. 3 is a block diagram showing functional blocks that pertain to data security of the electronic apparatus (home server) according to the embodiment of the present invention upon occurrence of an emergency situation;

FIG. 4 is a table showing important data which are to undergo a data security process in the electronic apparatus (home server) according to the embodiment of the present invention;

FIG. 5 shows an example of a security process setup table of the electronic apparatus (home server) according to the embodiment of the present invention; and

FIG. 6 is a flowchart showing the operation sequence that pertains to data security of the electronic apparatus (home server) according to the embodiment of the present invention upon occurrence of an emergency situation.

### DETAILED DESCRIPTION OF THE INVENTION

Embodiment of the present invention will be described hereinafter with reference to the accompanying drawings.

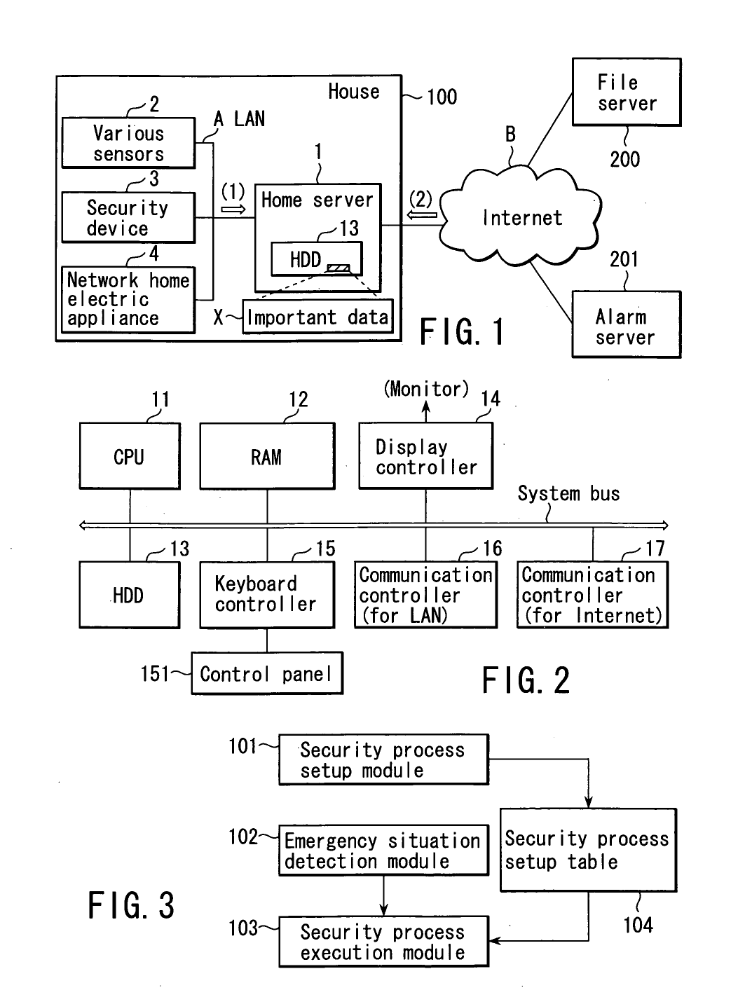

FIG. 1 shows the use pattern of an electronic apparatus (home server 1) according to an embodiment of the present invention.

This home server 1 is an electronic apparatus set up in, e.g., a living room in a house 100. The home server 1 is connected to a LAN (A) set in the house 100, and also to Internet B. Various sensors 2 for detecting disasters (e.g., a sensor that monitors the room temperature and detects a fire), and a security device 3 for detecting housebreaking of any suspicious individual (e.g., a device that monitors the presence/absence of interception of radiated infrared rays and detects a burglar) are connected to the LAN (A). The home server 1 receives signals from the various sensors 2 and security device 3 via the LAN (A) to detect disasters and housebreaking by suspicious individuals.

Also, network home electric appliances 4 such as a recorder/player, air-conditioner, and the like which have a communication function are connected to the LAN (A). The home server 1 controls to drive these network home electric appliances 4 via the LAN (A) on the basis of operation instructions received via Internet B. That is, the user can remotely control the network home electric appliances 4 from, e.g., a place where he or she is using a PDA terminal or the like. Upon reception of signals indicating occurrence of an abnormality from two or more network home electric appliances 4 within a predetermined period of time, the home server 1 determines that some emergency situation has occurred.

Furthermore, the home server 1 has a so-called browser function. Hence, the user can establish connection to a Web server via Internet B to browse published information and to make electronic commerce transactions. Upon making such electronic commerce transaction, the user uses an ID number used to make the partner side authenticate himself or herself, a public key used to decrypt encrypted data transmitted from the partner side, and the like. The ID number and public key are stored in a storage unit (HDD 13) of the home server 1.

Important data X such as these ID number, public key, and the like must be protected from losses due to disasters, theft by suspicious individuals, and the like. For this purpose, the home server 1 takes predetermined measures for respective data and the types of emergency situations upon occurrence of emergency situations such as disasters, housebreaking of a suspicious individual, and the like.

More specifically, for example, setups that execute both save and delete processes for data A, but execute only a delete process for data B, and only a save process for data C can be set, thus allowing more flexible management. For example, upon detection of housebreaking of a suspicious individual, data are saved and deleted via communications. However, upon occurrence of any disaster such as a fire or the like, data are saved but are not deleted. Hence, measures to be taken in correspondence with the types of emergency situations can be set. Furthermore, upon occurrence of, e.g., a fire, since the set measure must be taken for data with higher importance levels in preference to those with lower importance levels, priority can be set.

Note that a file server 200 in FIG. 1 is a Web server which is designated in advance as a save destination of important data X. Also, an alarm server 201 is a Web server that delivers various alarms (e.g., notifies an approach of a typhoon). That is, the home server 1 has two detection methods, i.e., detection of emergency situations by receiving signals via the LAN (A) ((1) in FIG. 1) and detection of emergency situations by receiving signals via Internet B ((2) in FIG. 1).

FIG. 2 is a block diagram showing the device arrangement of the home server 1.

As shown in FIG. 2, the home server 1 comprises a CPU 11, a RAM 12, the HDD 13, a display controller 14, a keyboard controller 15, a communication controller 16 (for the LAN), and a communication controller 17 (for the Internet), which are connected to a system bus.

The CPU 11 controls the whole home server 1, and executes various programs stored in the RAM 12. The RAM 12 is a storage medium serving as a main storage of this home server 1. The RAM 12 stores various programs to be executed by the CPU 11 and various data used in these programs. On the other hand, the HDD 13 is a storage medium serving as an external storage of the home server 1. The HDD 13 stores various programs and various data in large quantities as an auxiliary unit of the RAM 12. Important data X such as the ID number, public key, and the like are stored in the HDD 13.

The display controller 14 is responsible for the output side of a user interface of this home server 1. The display controller 14 controls, e.g., an externally connected monitor or the like to display screen data generated by the CPU 11. On the other hand, the keyboard controller 15 is responsible for the input side of the user interface of the home server 1. The keyboard controller 15 transfers the operation contents of a control panel 151 which is arranged on the front side wall or the like of a housing of the home server 1 to the CPU 11.

Both the communication controller 16 (for the LAN) and the communication controller 17 (for the Internet) control communications via networks. That is, the communication controller 16 controls communications via the LAN (A). The communication controller 17 controls communications via Internet B.

FIG. .3 shows functional blocks that pertain to data security of the home server 1 upon occurrence of an emergency situation.

In order to assure the data security upon occurrence of an emergency situation, the home server 1 comprises processing modules, i.e., a security process setup module 101, emergency situation detection module 102, and security process execution module 103, and a data module, i.e., a security process setup table 104, as shown in FIG. 3. Note that the respective processing modules are implemented by utility programs which are stored in the RAM 12 and executed by the CPU 11. On the other hand, the data module is assured on the HDD 13, and is accessed via the RAM 12.

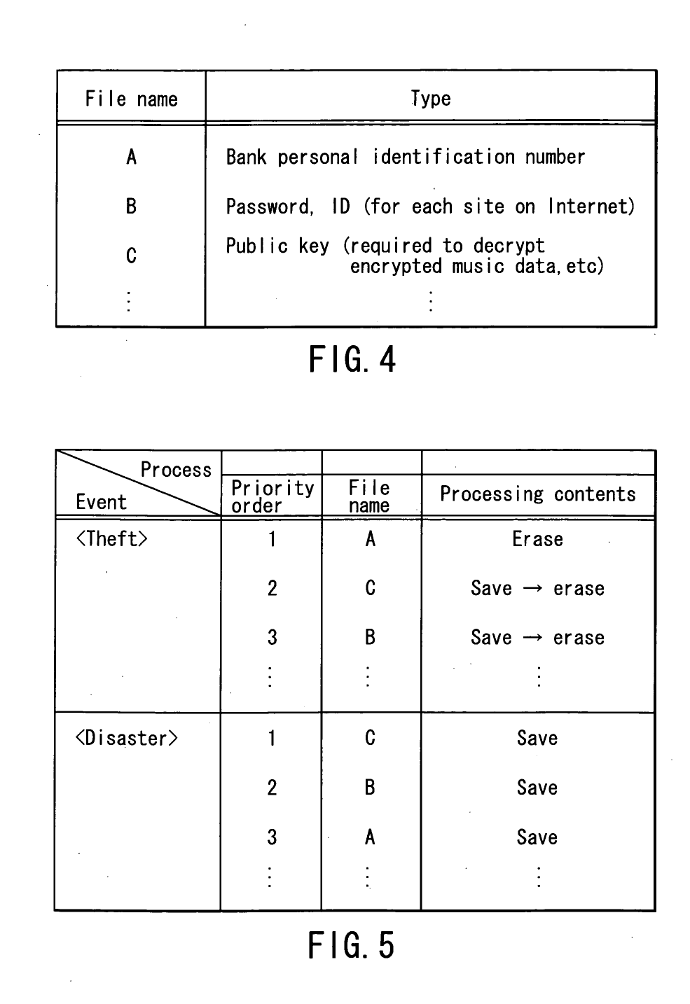

The security process setup module 101 sets measures to be taken for important data X upon occurrence of emergency situations in correspondence with respective data and the types of emergency situations, and stores the setup contents in the security process setup table 104. Assume that there are files of types shown in FIG. 4 as important data X, the security of which must be maintained upon occurrence of emergency situations.

File A: holds the personal identification number of a bank

File B: holds the passwords and ID numbers of respective sites on the Internet

File C: a public key required to decrypt encrypted music data and the like

The security process setup module 101 categorizes the processing contents of respective files to those for “theft” and “disaster”, as shown in FIG. 5, and sets them together with their priority levels. Note that “theft” corresponds to a case wherein housebreaking of a suspicious individual has been detected based on a signal from the security device 3. On the other hand, “disaster” corresponds to a case wherein occurrence of a disaster has been detected based on signals from the various sensors 2 or network home electric appliances 4, or notification from the alarm server 201. These housebreaking of a suspicious individual and occurrence of a disaster are detected by the emergency situation detection module 102 by monitoring signals from the LAN (A) and Internet B.

In the example of FIG. 5, upon detection of a theft, security processes begin in the order of file A, file C, and file B. These processes are set for respective files: file A undergoes only an erase process; file C undergoes a save process to the file server 200 and an erase process; and file B also undergoes a save process to the file server 200 and an erase process.

On the other hand, upon detection of a disaster, security processes begin in the order of file C, file B, and file A. These processes execute only save process of these files to the file server 200, and do not erase them. Note that the processes set on this security process setup table 104 are executed by the security process execution module 103 that receives a message from the emergency situation detection module 102.

The security process setup module 101 also has a function of setting the address of the file server 200 as a save destination of respective files.

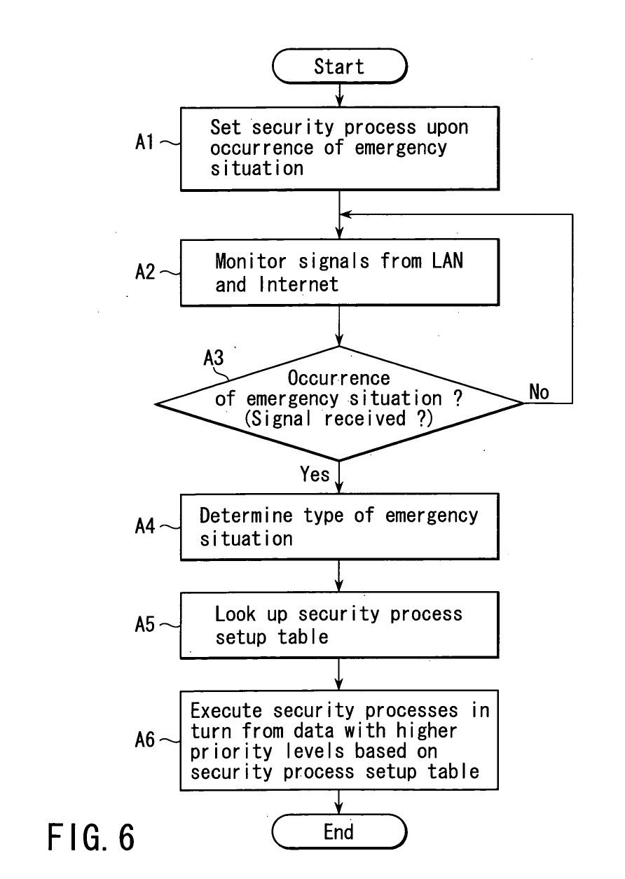

FIG. 6 is a flowchart showing the operation sequence that pertains to data security of the home server 1 upon occurrence of emergency situations.

The security process setup module 101 sets security processes of important data X upon occurrence of emergency situations for respective data and the respective types of emergency situations, and stores the setup contents in the security process setup table 104 (step A1).

The emergency situation detection module 102 monitors signals from the LAN (A) and Internet B (step A2). Upon reception of some signal from the LAN (A) or Internet B (YES in step A3), the module 102 determines the type of emergency situation based on the received signal, and notifies the security process execution module 103 of that determination result, i.e., detection of a theft or disaster (step A4).

Upon reception of this notification, the security process execution module 103 looks up the security process setup table 104 (step A5), and executes security processes in turn from data with higher priority level on the basis of the security process setup table 104 (step A6).

As described above, according to the home server 1, upon occurrence of emergency situations such as disasters, housebreaking by a suspicious individual, and the like, predetermined measures can be taken for respective data and the respective types of emergency situations.

In the aforementioned embodiment, the security processes of important data X are set for respective data and the respective types of emergency situations. Alternatively, the effects of the present invention can be obtained when security processes may be set for either respective data or the respective types of emergency situations.

Also, the file server 200 as a save destination of important data X may be set for each data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus comprising:
a storage unit which stores data;
a setting unit configured to set a predetermined process to be taken for data stored in the storage unit upon occurrence of an event;
a detection unit configured to detect if the event has occurred; and
a data processing unit configured to take the predetermined process set by the setting unit, when the detection unit detects that the event has occurred.

2. The electronic apparatus according to claim 1, wherein the setting unit sets priority levels of the predetermined process upon occurrence of the event for respective data.

3. The electronic apparatus according to claim 1, wherein the setting unit sets a data delete process upon occurrence of the event.

4. The electronic apparatus according to claim 1, wherein the setting unit sets a transmission process of data to another electronic apparatus connected via a network upon occurrence of the event.

5. The electronic apparatus according to claim 1, wherein the setting unit sets a transmission process of data to another electronic apparatus connected via a network and a data delete process after completion of transmission upon occurrence of the event.

6. The electronic apparatus according to claim 1, wherein the detection unit detects occurrence of the event on the basis of a signal sent from a disaster detection sensor.

7. The electronic apparatus according to claim 1, wherein the detection unit detects occurrence of the event on the basis of a signal sent from a security device which detects housebreaking of any suspicious individual.

8. The electronic apparatus according to claim 1, wherein the detection unit detects occurrence of the event on the basis of a signal sent from a home electric appliance connected via an intra-network.

9. The electronic apparatus according to claim 1, wherein the detection unit detects occurrence of the event on the basis of an alarm sent from a server computer connected via an Internet.

10. A data processing method comprising:
setting a predetermined process to be taken for data stored in a storage unit upon occurrence of an event;
detecting if the event has occurred; and
taking the predetermined process, when it is detected that the event has occurred.
